(19) United States
(12) Patent Application Publication
(10) Pub. No.: US 2005/0214419 A1
(43) Pub. Date: Sep. 29, 2005

(54) Method and apparatus for providing instantaneous, real-time data for extrusion process control

(76) Inventors: Rick A. Aberle, Sabetha, KS (US); Gordon R. Huber, Sabetha, KS (US); Bradley S. Strahm, Sabetha, KS (US); Kaleb M. Beyer, Sabetha, KS (US)

Correspondence Address: Hovey Williams LLP;Suite 400, 2405 Grand Boulevard, Kansas City, MO, 64108, US

(21) Appl. No.: 10/812,325

(22) Filed: Mar. 29, 2004

(51) Int. Cl. A23L 1/24

(52) U.S. Cl. 426/233

(57) ABSTRACT

An extrusion system (10) is provided having an extruder (12), raw material input apparatus (14), dryer (16) and controller (18). The system (10) is equipped with strategically placed analyzers (22-26) designed to measure important parameters of the material input and the final extrudates; the analyzers (22-26) are coupled to controller (18), the latter also being operatively connected to the system components (12-16) for real-time operational control thereof. The analyzers (22-26) are preferably designed to generate analysis signals which pass through a cross-section of the material or extrudate, such as ultrasound, NIR or microwave analyzers.

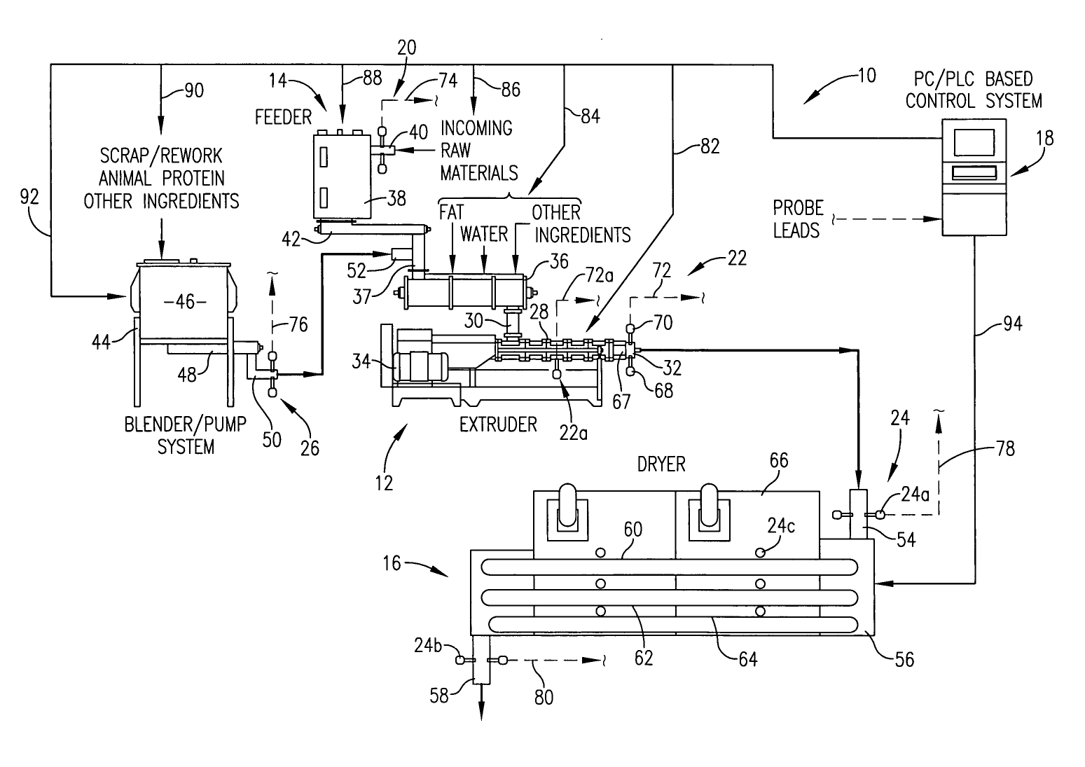

### BACKGROUND OF THE INVENTION

1. Field of the Invention

The present invention is broadly concerned with improved methods and apparatus for extrusion processing wherein a plurality of analyzers are strategically placed throughout the system so as to afford a means of instantaneous, real-time process modification allowing the user to consistently produce high quality extrudates. More particularly, the invention is concerned with such methods of apparatus wherein first, second and third analyzers are located in association with material feeding apparatus for an extruder, the extruder itself adjacent the die thereof, and the downstream, post-extrusion dryer, and wherein these analyzers are coupled with a microprocessor-type controller which receives analysis data and is operable to adjust the extrusion system components. The extruder is preferably equipped with an ultrasound analyzer for measuring important rheological properties of the material within the barrel during extruder operation, and a near-infrared (NIR) analyzer for ascertaining compositional properties of the material.

2. Description of the Prior Art

An important goal of modern-day extrusion processors is the production of in-specification final products with a minimum of start up and system upset conditions which often result in significant quantities of sub-standard product. Due to the complex nature of the physical and chemical reactions inherent in extrusion processing, control of an extrusion system often becomes as much an “art” as a scientific endeavor. More specifically, in typical food extrusion processing systems, final product quality is often defined by nutrient and chemical composition, density, moisture and percentage cook. In processing such extrudates, recipe raw ingredients are selected which meet defined nutrient and mechanical requirements, and the recipe is processed so as to achieve the desired in-specification final product. During start up of the extrusion system, adjustments are made by the operator in an attempt to quickly begin producing the desired final products. However, this can at times be a lengthy process. Further, a manufacturing cycle may begin with a product in-specification, but the product may then drift out of acceptable parameters. Finally, a later run to produce the same product and using the same raw materials and processing conditions may not in fact give the same final product.

The problems of extrusion system control largely derive from the fact that the system operators are unable to gain access, on a real-time basis, to information that accurately describes process parameters and product characteristics that affect the final product. Furthermore, if an operator is able to obtain such information, the amount and presentation thereof eliminates any real chance of timely system modifications that can positively alter the system. As a result, operators often rely on visual inspection complimented by “at-line” measurements of such basic parameters such as temperature, moisture content and density. If a problem is detected, either through the at-line measurements or by visual inspection, the operator typically attempts to rectify the problem through process adjustments. Unfortunately, the nature of many problems often dictates a shut-down of the process in order to sample raw materials and to completely laboratory-based quality control testing in order to ascertain the cause of the problem. Moreover, differences in operator experience and expertise can result in different levels of effective process control, resulting in undesirable final product variability.

Laboratory-based quality control strategies invariably take on a sample and hold routine. Raw ingredients and final products are randomly and systematically sampled, the samples are taken to a lab, and the necessary tests are conducted to ensure that the raw materials and/or product being manufactured are within specifications. Results of the sample testing are then inferred to an entire ingredient or product population. However, the sample and hold strategy is by definition a reactive quality control procedure. Further, this time-honored method results in dramatic costs because of production of waste, and attended rework and disposal problems. For example, if a laboratory test confirms a problem in starting materials or final extrudates, the time lapse between sample taking and problem identification can be considerable, and in the meantime very significant quantities of out of specification product have been produced.

Furthermore, the practice of inferring sample results to an entire population raises potential problems in its own right. These issues center around the fact that it is difficult to ensure that a given sample is representative of an entire population. This problem can be somewhat assuaged by increasing the number of samples taken. However, this increases the sampling cost and also the time lag between sample taking and problem identification.

In short, current process and quality control methods in extrusion systems are at best barely adequate and at worse falsely give manufacturers the illusion of ensured quality; also, these extant methods result in waste products, high inventory carrying costs, reduced product repeatability, and degraded plant efficiency. There is accordingly a real and unsatisfied need in the art for improved methods of real-time quality control in extrusion systems.

### SUMMARY OF THE INVENTION

The present invention overcomes the problems outlined above and provides improved extrusion systems which include an extruder (either single or multiple screw) having a material inlet and a restricted extrudate die or outlet, together with apparatus for delivering material to be extruded to the inlet and a dryer operably coupled with the extruder outlet for receiving and drying of extrudate, in order to thereby yield a finished product. Broadly speaking, the systems of the invention include a first analyzer operably coupled with the material feeding apparatus and for analysis of a selected property of the material being fed to the extruder. A second analyzer is also provided which is coupled to the extruder for analysis of a selected product property of the extrudate. Finally, a third analyzer is coupled with the dryer for analysis of a selected property of the extrudate during or after drying thereof. These analyzers (and in preferred forms more than three such analyzers are provided) are all connected to a controller such as a microprocessor which is also coupled to the operative components of the system. The controller receives data from the respective analyzers and creates so-called product “signatures” identifying crucial properties of the incoming material to be extruded, the extrudate and the drying process. The operation of the overall extrusion system is adjusted in response to such signature data, so that necessary process modifications are made on an almost instantaneous, real-time basis. This provides effective ongoing extrusion system control and also negates the need for ongoing sampling and laboratory-based testing.

In preferred forms, the individual analyzers are selected from the group consisting of microwave, infrared (especially NIR), X-ray and ultrasound analyzers. It has been found that analyzers which generate an analysis signal which passes through a cross-section of the material or extrudate give more valuable information, as compared with reflective-type analyzers which generate an analysis signal which merely impinges on the surface of the material or extrudate.

A multiplicity of different material or extrudate parameters can be analyzed in accordance with the intention. For example, the incoming materials may be analyzed to ascertain moisture content, protein content, fat content, starch content, particle size, color and/or contaminants. The extrudate, either at the extruder or during or after drying, may be analyzed for all of the foregoing as well as viscosity, pH, degree of cook and specific gravity.

An especially preferred system includes an extruder having both an ultrasound analyzer and a complemental NIR analyzer. The former may be advantageously mounted to the extruder barrel at a mid-barrel location, while the NIR analyzer is preferably mounted downstream of the extruder screw just before the final extrusion die; in other preferred embodiments, the two analyzers would be mounted at the same location adjacent the end of the barrel upstream of the die, and another ultrasound analyzer would be provided mid-barrel. The ultrasound analyzer is particularly suited for measuring important rheological properties, whereas the NIR analyzer is suited for determining compositional details.

### BRIEF DESCRIPTION OF THE DRAWING

The single FIGURE is a schematic flow chart representation of a preferred extrusion system in accordance with the invention.

### DETAILED DESCRIPTION OF THE PREFERRED EMBODIMENT

The single FIGURE depicts a typical extrusion processing system 10 including an extruder 12, apparatus broadly referred to by the numeral 14 for delivery of material to the extruder for processing thereof, a dryer 16 designed to dry extrudate from the extruder 12, and a microprocessor-based controller 18. The latter is operably coupled with a plurality of analyzers 20, 22, 24, and 26 associated with the components of system 10. A plurality of temperature sensors may also be used in the system 10 at various locations. These sensors are quite conventional and extensively used, and thus need not be described in detail.

The extruder 12 in the form shown is a conventional single or twin screw extruder including a multiple-section barrel 28 having an inlet 30 and a restricted orifice outlet die 32. Elongated, flighted, axially rotatable screw(s) are housed within barrel 28 and are driven through motor and drive assembly 34. In addition, the overall extruder 10 includes a preconditioner 36 having an inlet 37 and an outlet coupled with extruder inlet 30. The preconditioner is designed to receive incoming dry materials and to subject such materials to a degree of pre-cooking together with moisturization through addition of water and/or steam; additionally, fat or other ingredients may be added at preconditioner 36. The extruder 12 and preconditioner 36 are preferably those commercialized by Wenger Manufacturing, Inc. of Sabetha, Kans.

The material delivery 14 includes a live-bottom feeder 38 having an inlet 40 for incoming raw materials as well as a screw feeder 42 coupled to preconditioner inlet 37. Furthermore, in this embodiment, a blender/pump 44 is provided which is designed to receive waste, scrap and/or rework material, animal protein, or other ingredients. The blender/pump 44 is preferably of the type depicted and described in application for U.S. patent Ser. No. 10/713,942 filed Nov. 14, 2003 and incorporated by reference herein. This preferred blender/pump includes a chamber 46 equipped with mixing elements as well as a dual-screw feeder section 48. As illustrated, the feeder section 48 is connected with a conveying line 50 connected to secondary inlet 52 of preconditioner inlet 37.

Dryer 16 is also conventional and includes a wet product inlet 54, a drying chamber 56 and a dried product outlet 58. In the form shown, the chamber 56 has three vertically spaced apart flights 60, 62, and 64 together with a burner assembly 66 designed to generate hot drying gasses within the chamber 56. During drying operations, incoming wet product is received at inlet 54 and is conveyed in three passes along the length of chamber 56 until the product in a dried condition passes through outlet 58.

The controller 18 is any one of a number of commercially available personal computer/PLC microprocessor-based devices having multiple control inputs and outputs. Such a controller is individually programmable for a particular system to be controlled.

The extruder 12 is equipped with at least one analyzer 22, and preferably includes a second analyzer 22a. The analyzer 22 is a near-infrared analyzer and may be positioned downstream of the end of the extrusion screws and just upstream of the die 32, while analyzer 22a is an ultrasound analyzer which may be positioned along the length of barrel 28 as shown, with another such ultrasound analyzer adjacent or proximal to the NIR analyzer 22. The analyzers 22 and 22a are able to analyze a continuous stream of material passing along the barrel 28 during extrusion. The analyzer 22 as shown includes a mounting head 67 supporting a transmitting probe 68 and an opposed receiver probe 70 such that the transmitting probe 68 generates an analysis signal which passes through the cross-section of the material being extruded with such signal being received by probe 70. It will be seen that the analyzer 22 is operably coupled to controller 18 via lead 72.

The ultrasound analyzer 22a includes a sonic probe and a complemental pulser receiver which need not be in opposed relationship but can be located in side-by-side relationship. In such a case the ultrasound signal is reflected off of the screw within barrel 28 (or if the analyzer 22 is positioned proximal to analyzer 22 on head 67, the signal would be reflected off of the opposed surface of the head). A lead 72a connects the analyzer 22a with controller 18.

As noted, it is preferred that the analyzer 22 is an NIR analyzer while the analyzer 22a is an ultrasound analyzer. One suitable NIR analyzer is commercialized by ESE, Inc. of Marshfield, Wis. A useful ultrasound analyzer is produced by UTex Scientific of Ottawa, Canada. The preferred microwave analyzer may be of the guided microwave type produced by Thermoelectron Corporation. While not shown, it will also be appreciated that, depending upon the degree of process control desired, other analyzers may be used with extruder 12, for example at preconditioner 36 or at inlet 30.

The use of ultrasound analyzer(s) 22a associated with extruder 12 provide very significant detection advantages. That is, ultrasound analyzers can measure speed and attenuation of the ultrasound signal, which in turn provides valuable information concerning rheological properties of the material within the extruder, e.g., viscosity, porosity and elasticity. These rheological properties are very dependent upon composition of the material within the extruder 12. Thus, if through a system upset or other untoward event there is a significant change in the properties of the materials within the extruder, or the operational conditions of the extruder change, this can be essentially immediately detected by use of the analyzers. Specifically, the NIR analyzer is especially suited for detecting compositional changes, while the ultrasound analyzer(s) are capable of quickly detecting rheological changes due to differences in operational conditions. As a consequence, the fact of a system upset is detected along with the cause of the upset. Therefore, properly directed remedial measures can be taken on a real-time basis. On the other hand, the preferred NIR analyzers are particularly useful for measuring compositional details such as moisture, fat, protein and starch contents, pH values, particle size, color, contaminants, and also provide confirmatory information respecting viscosity. Thus, the use of NIR and ultrasound analyzer(s) in tandem on the extruder 12 yields a particularly advantageous suite of real-time information.

The analyzers 20, 26 associated with material delivery apparatus 14 are advantageously positioned at feeder inlet 40 and at blender/pump outlet 26. Again, one or more of the preferred dual-probe analyzers may be used in this context, with each such analyzer equipped with a lead 74, 76 to controller 18. In the case of feeder 38, the analyzer 20 would normally be designed to analyze for moisture, protein, fat and/or starch content, particle size, color and contaminants. The analyzer 26, depending upon the nature of the products fed to blender/pump 44, would typically be used to analyze for the foregoing as well as viscosity, pH, degree of cook, or density/specific gravity. As in the case of the extruder analyzers, plural analyzers 20, 26 may be used and such is often preferred.

The dryer 16 in the illustrated embodiment is equipped with a number of analyzers, specifically analyzer 24a at inlet 54, 24b at outlet 58, and analyzers 24c within drying chamber 56. These analyzers would normally be tuned to analyze for moisture content, color, density/specific gravity of the product during or after drying thereof. As before, each such analyzer has an associated lead to the controller 18, such as leads 78 and 80 from the receiver probes of the analyzers 24a, 24b.

As illustrated, the controller 18 is coupled to the above-described probe leads (only one such lead connection is shown for simplicity). Additionally, the controller 18 is connected to the components of the system 10. Thus, by leads 82, 84 the controller 18 is connected to the extruder 12, which may be to the motor and drive assembly 34, and/or to ingredient addition to the preconditioner 36 and/or barrel 28. Similarly, the controller 18 can control the flow of incoming raw materials to and out of feeder 38, and the flow of waste/rework or other ingredients to and out of blender/pump 44 through leads 86, 88, 90, and 92. Dryer control is effected through schematically depicted feed 94 between controller 18 and dryer 16 which may be connected to the burner 66 or the drive(s) for the flights 60-64. It will be appreciated in this respect that the control leads are connected to associated pumps, motors or drives forming a part of the controlled system components, and that such connections and control strategies are well within the scope of the art.

During operation of system 10, the incoming raw materials are fed from feeder 38 into and through preconditioner 36 and ultimately into and through extruder barrel 28. At the same time, if waste or rework or similar materials are being extruded, such are handled at blender/pump 44 so that these materials are merged with the raw materials from feeder 38 to form a combined input to extruder barrel 28. Extrusion is carried out in the normal fashion, involving subjecting the incoming material to increasing levels of temperature, pressure and shear, culminating in extrusion through die 32. The wet extrudate is then conveyed to dryer 16 wherein it is dried to a final product moisture.

During the course of this extrusion operation, the analyzers described above serve to continuously and in real-time analyze the raw materials to the extruder, the extrudate and the product during or after drying. The comprehensive monitoring of multiple facets of the process and product provides a control capability unavailable in prior art systems. Moreover, because the controller 18 is connected to the various system components, corrective action can be taken immediately upon discovery of an out of specification condition. This may involve human intervention, or could be programmed into controller 18 for automatic operation.

One goal of the invention is to essentially eliminate the conventional laboratory based quality control procedures common in the art. That is to say, over time with a given extrusion system, a database of acceptable material or product “signatures” representing may be developed which will account for all normal variability in input materials, extrusion parameters or product specifications. As a corollary, the database would include a remedial decision matrix in the form of actions which may be taken to remedy any occasions where non-acceptable parameters are found. As a consequence, the need for periodic sampling and laboratory testing of raw materials or final extrudates is rarely if ever needed.

Concurrently filed applications for U.S. Letters Patent entitled Animal Protein Products Usable as Ingredients in Extruded Products (Ser. No. ______, filed______ ) and Method and Apparatus for Providing Products of Consistent Properties for Extrusion (Ser. No. ______, filed ______) are incorporated by reference herein.

1. In an extrusion system comprising an extruder presenting a material inlet and a restricted extrudate outlet, apparatus for delivering material to be extruded to said inlet, and a dryer operably coupled with said outlet for receiving and drying of said extrudate, the improvement which comprises:
a first analyzer operably coupled with said apparatus for analysis of a selected property of said material;
a second analyzer operably coupled with said extruder for analysis of a selected property of said extrudate;
a third analyzer operably coupled with said dryer for analysis of a selected property of the extrudate during or after drying thereof; and
a controller operably connected with said first, second, and third analyzers and with said apparatus, said extruder, and said dryer,
said controller operable to receive analysis data from said analyzers and to adjust the operation of one or more of said apparatus, said extruder, and said dryer to create a desired product from said dryer.

2. The extrusion system of claim 1, at least certain of said analyzers comprising a transmitting probe operable to generate a signal adapted to pass through a cross-section of the material or extrudate being analyzed, and a receiver probe in opposed relationship to the transmitter probe to receive said signal.

3. The extrusion system of claim 2, each of said analyzers selected from the group consisting of microwave, infrared, and X-ray analyzers.

4. The extrusion system of claim 1, said second analyzer comprising an ultrasound analyzer.

5. The extrusion system of claim 1, said apparatus comprising a feeder adapted to receive incoming raw materials and to deliver such raw materials to said extruder inlet, said first analyzer oriented to analyze a selected characteristic of said incoming raw material.

6. The extrusion system of claim 5, said selected property of said material selected from the group consisting of moisture content, protein content, fat content, starch content, particle size, color, and contaminants.

7. The extrusion system of claim 1, said second analyzer comprising an ultrasound analyzer coupled to said extruder between said inlet and said outlet.

8. The extrusion system of claim 1, said selected property of said extrudate selected from the group consisting of moisture content, protein content, fat content, starch content, color, viscosity, pH, degree of cook, density, specific gravity, viscosity, porosity and elasticity.

9. The extrusion system of claim 1, said dryer including an inlet for receiving extrudate from said extruder, a drying chamber, and an outlet for dried extrudate, said third analyzer operably coupled with said dryer adjacent said dryer inlet, said dryer outlet or at said drying chamber.

10. The extrusion system of claim 9, said selected product of the extrudate during or after drying thereof selected from the group consisting of moisture content, color, density and specific gravity.

11. The extrusion system of claim 9, said third analyzer comprising a plurality of individual analyzers respectively coupled adjacent said dryer inlet, said dryer outlet, and at least one region within said drying chamber.

12. The extrusion system of claim 11, said drying chamber including multiple drying flights, there being at least one analyzer associated with each of said drying chamber flights.

13. The extrusion system of claim 1, said system including a blending device for receipt of waste products, said blending device operable to deliver said waste products to said extruder, there being a fourth analyzer operably coupled with said blending device for analysis of a selected product of the waste products.

14. The extrusion system of claim 13, said fourth analyzer selected from the group consisting of microwave, infrared, X-ray and ultrasound analyzers.

15. The extrusion system of claim 13, said fourth analyzer operable to detect a property selected from the group consisting of moisture content, protein content, fat content, starch content, particle size, color, and contaminants.

16. A method of controlling an extrusion system including an extruder presenting a material inlet and a restricted extrudate outlet, apparatus for delivering material to be extruded to said inlet, and a dryer operably coupled with said outlet for receiving and drying of said extrudate, said method comprising the steps of:
analyzing a selected property of said material using a first analyzer;
analyzing a selected property of said extrudate using a second analyzer;
analyzing a selected property of the extrudate during or after drying thereof using a third analyzer;
directing data derived from said first, second and third analyzers to a controller, said controller coupled with said apparatus, said extruder and said dryer; and
operating said controller in response to said data to adjust the operation of one or more of said apparatus, said extruder and said dryer to create a desired product from the dryer.

17. The method of claim 16, at least certain of said analyzers comprising a transmitting probe operable to generate a signal adapted to pass through a cross-section of the material or extrudate being analyzed, and a receiver probe in opposed relationship to the transmitter probe to receive said signal.

18. The method of claim 17, each of said analyzers selected from the group consisting of microwave, infrared, and X-ray analyzers.

19. The method of claim 18, said second analyzer comprising an ultrasound analyzer.

20. The method of claim 16, said apparatus comprising a feeder adapted to receive incoming raw materials and to deliver such raw materials to said extruder inlet, said first analyzer oriented to analyze a selected characteristic of said incoming raw material.

21. The method of claim 20, said selected property of said material selected from the group consisting of moisture content, protein content, fat content, starch content, particle size, color, and contaminants.

22. The method of claim 16, said second analyzer comprising an ultrasound analyzer coupled to said extruder between said inlet and said outlet.

23. The method of claim 16, said selected property of said extrudate selected from the group consisting of moisture content, protein content, fat content, starch content, color, viscosity, pH, degree of cook, density, specific gravity, viscosity, porosity and elasticity.

24. The method of claim 16, said dryer including an inlet for receiving extrudate from said extruder, a drying chamber, and an outlet for dried extrudate, said third analyzer operably coupled with said dryer adjacent said dryer inlet, said dryer outlet or at said drying chamber.

25. The method of claim 24, said selected product of the extrudate during or after drying thereof selected from the group consisting of moisture content, color, density and specific gravity.

26. The method of claim 24, said third analyzer comprising a plurality of individual analyzers respectively coupled adjacent said dryer inlet, said dryer outlet, and at least one region within said drying chamber.

27. The method of claim 26, said drying chamber including multiple drying flights, there being at least one analyzer associated with each of said drying chamber flights.

28. The method of claim 16, said system including a blending device for receipt of waste products, said blending device operable to deliver said waste products to said extruder, there being a fourth analyzer operably coupled with said blending device for analysis of a selected product of the waste products.

29. The method of claim 28, said fourth analyzer selected from the group consisting of microwave, infrared, X-ray and ultrasound analyzers.

30. The method of claim 28, said fourth analyzer operable to detect a property selected from the group consisting of moisture content, protein content, fat content, starch content, particle size, color, and contaminants.

31. In an extruder including an elongated barrel adapted to receive an elongated, axially rotatable screw and presenting a material inlet and a material outlet, the improvement which comprises an ultrasound analyzer operably coupled with said barrel and oriented for generating an ultrasound signal which will pass through material within said barrel during operation of the extruder.

32. The extruder of claim 31, said analyzer being secured to said barrel between said inlet and said outlet.

33. The extruder of claim 31, including an infrared analyzer operably coupled to said extruder.

34. The extruder of claim 33, said infrared analyzer including a transmission probe and an opposed detection probe.

35. The extruder of claim 33, said infrared analyzer in spaced relationship to said ultrasound analyzer.

36. The extruder of claim 31, said ultrasound analyzer operably coupled with a microprocessor for receiving and storing ultrasound analysis data from said ultrasound analyzer.

37. The extruder of claim 36, said analyzer also operably coupled with said extruder for varying the operation of the extruder in at least partial response to said ultrasound analysis data.
